(19) United States
(12) Patent Application Publication
(10) Pub. No.: US 2004/0196207 A1
(43) Pub. Date: Oct. 7, 2004

(54) Collapsible antenna assembly for portable satellite terminals

(76) Inventors: Michael John Schefter, Vancouver (CA); Lowell McAllan Orcutt, Vancouver (CA); Christopher Michael Senger, Burnaby (CA); Leonard Albert Russell, Delta (CA)

Correspondence Address: Clifford W. Vermette, Vermette & Co., Box 40, Granville Square, 200 Granville Street, Suite 230, Vancouver, BC, V6C 1S4, CA

(21) Appl. No.: 10/405,220

(22) Filed: Apr. 3, 2003

(30) Foreign Application Priority Data
Apr. 2, 2003 (CA) 2,424,774

(51) Int. Cl. H01Q 1/12

(52) U.S. Cl. 343/878; 343/840

(57) ABSTRACT

A collapsible antenna assembly for portable, outdoor satellite communication systems is provided. When connected to complementary electronics, the apparatus enables the transmission and reception of communications signals from any selected terrestrial location by means of a satellite link. The apparatus is implemented in a physical form that minimizes the overall physical dimensions such that portability is improved. The apparatus consists of an antenna reflector, transmit assembly, feed horn assembly, a boom, a tripod, and a mounting platform, which permits the antenna reflector to be oriented to operate with any selected satellite. The entire apparatus can be folded and disassembled to fit inside of a suitcase.

### FIELD

The present invention relates generally to portable wireless communications systems used for transmitting and receiving signals to and from satellites.

### BACKGROUND OF THE INVENTION

Satellite communications are used in an increasing variety of applications. The applications include television broadcasting, wherein a satellite transmitter is used to broadcast a signal to receiving earth terminals located within the area illuminated by the satellite transmitting antenna. Such systems commonly employ a receive terminal fixed in location, for home-based television reception, for example. Another application is for bidirectional transmission of information between two or more fixed terrestrial locations via satellite. Such systems generally employ large antennae, mounted on rotatable platforms, capable of accessing one or more satellites.

Advancements in microwave technology have significantly reduced the size and cost of the electronic components used for transmission and reception of satellite signals. These advancements enable construction of small, lightweight portable earth terminals, which can be moved from location to location, and can be rapidly deployed. Such portable earth terminals have application in the areas of satellite newsgathering, transmission of data and video from remote sites (e.g. surveying and exploration applications), and in military communications systems.

Prior art terrestrial stations have been developed by essentially miniaturizing known system components, without maximizing portability and without taking advantage of alternative configurations made possible by new microwave technologies. Prior art stations often comprise multiple independent units or components, which must be interconnected to form a terrestrial station. Such stations are more costly to ship, require additional set up time, and involve a risk of loss of one or more of the components and/or of incompatibility of components. In addition, the need for multiple containers to carry all of the independent components often dictates that more than one person is needed to move and assemble the station. Where greater compactness has been achieved, it has been at the expense of smaller antenna sizes, which reduce the overall system gain achievable, thus lowering the communications potential of such systems. Also, such systems are not designed for rapid stowage and deployment by relatively mechanically unskilled personnel who did not possess specialized tools.

In one example of the prior art, U.S. Pat. No. 5,660,366, issued to Palmer, discloses a portable earth terminal which is capable of receiving signals from a satellite, but not of transmitting signals to a satellite. The apparatus disclosed by Palmer is intended to be transported in a vehicle, such as a recreational vehicle, and requires a separate antenna.

U.S. Pat. No. 5,019,833, issued to Nonaka, discloses a portable parabolic antenna capable of receiving satellite signals only. The antenna cannot be compacted for stowage or transport.

U.S. Pat. No. 5,999,839, issued to Schefte et al., discloses an antenna system consisting of two approximately equal antenna sections, which can be either folded or telescoped. In it's stowed or collapsed state, the size of the antenna is reduced only by a factor of two.

In U.S. Pat. No. 4,816,838, issued to Mizuno et al., a flat plate receive-only antenna is disclosed. The antenna is hinged to a mounting plate and cannot be folded or reduced in size for stowage or transport.

Another example of the prior art, U.S. Pat. No. 6,031,878, issued to Tomasz et al., discloses an apparatus for the reception of signals from a satellite by a fixed earth terminal. No means for transmitting a signal to a satellite is disclosed. Furthermore, the antenna is not an integral part of the disclosed apparatus, nor is it foldable or collapsible.

U.S. Pat. No. 5,915,020, issued to Tilford et al., discloses means for the reception of video signals from a satellite by a portable earth terminal. No means of transmitting a signal to a satellite is disclosed, neither are means for reducing the size of the antenna for stowage or transport.

U.S. Pat. No. 5,061,945, issued to Hull et al., discloses a portable satellite antenna consisting of fan-like segments, which collapse, with fan segments stacked one behind the other, such that the dimensions are approximately equal to that of a single fan segment. However, the antenna of Hull is mechanically complex, making it fragile and susceptible to damage or malfunction in harsh or dirty environments.

Accordingly, it is an object of the current invention to provide a rugged, compact and portable antenna assembly for a satellite terminal capable of transmitting and receiving voice, video, and data signals from remote locations.

It is a further object to provide an antenna assembly which can be reduced to a compact configuration that can be contained in a single suitcase-sized container and that can be carried by a single person without undue effort.

It is a further object to provide a portable antenna assembly capable of rapid deployment without the need for specialized tools.

### SUMMARY OF THE INVENTION

These and other objects have been realized in a portable antenna assembly capable of transmitting and receiving voice, video and data signals through a satellite link, when used with additional electronics, such as downconverters, upconverters, etc. The portable antenna assembly comprises an antenna, mounting platform, tripod, boom, transmit assembly, and feed horn assembly.

The antenna is in the form of a parabola, however, unlike conventional parabolic antennae, it is closer to a rectangle in shape than an ellipse. The rectangular shape results in antenna segments that fit conveniently and efficiently into a rectangular case. The antenna is fabricated from separable segments that can be fastened together, when the antenna is deployed, and taken apart, when the antenna is stowed. The fastenings for the segments are such that accurate and rapid assembly can be achieved by unskilled personnel without the need for specialized tools.

The antenna is connected to the mounting platform, which consists of two flat plates in close contact that swivel relative to one another about a central point. The mounting platform enables the antenna to be pointed in any direction in a horizontal plane. The antenna is connected to the mounting platform by a hinge point that allows the elevation angle of the antenna to be varied anywhere from horizontal to vertical. The mounting platform also includes a compass, an inclinometer, and a level indicator, all of which are useful in establishing a correct operating position for the antenna with respect to the ground and the satellite.

The feed horn assembly is supported at the focal point of the antenna by a boom arm attached to one of the segments of the antenna.

The portable antenna assembly is supported on three legs, which mount to the underside of the bottom plate of the mounting platform.

The portable antenna assembly is capable of being collapsed and contained within a single suitcase-sized unit that can be carried and handled by one person. The portable antenna assembly may be rapidly, easily and simply assembled and positioned to transmit and receive signals to and from a satellite, when used in conjunction with additional electronics, such as downconverters, upconverters, etc.

Other objects, features, aspects and advantages of the present invention will become apparent to those of ordinary skill from the following detailed description of the invention taken in conjunction with the accompanying drawings

### BRIEF DESCRIPTION OF THE DRAWINGS

The invention itself both as to organization and method of operation, as well as additional objects and advantages thereof, will become readily apparent from the following detailed description when read in connection with the accompanying drawings, wherein:

FIG. 1 is a perspective view of the portable antenna assembly ;

FIG. 2 is a cut away view of the Boom Arm;

FIG. 3 is a side view of the Feed Horn Assembly;

FIG. 4 is a rear perspective view of the portable antenna assembly; and

FIG. 5 is a side view of the portable antenna assembly in its fully collapsed or folded form.

### DETAILED DESCRIPTION OF THE INVENTION

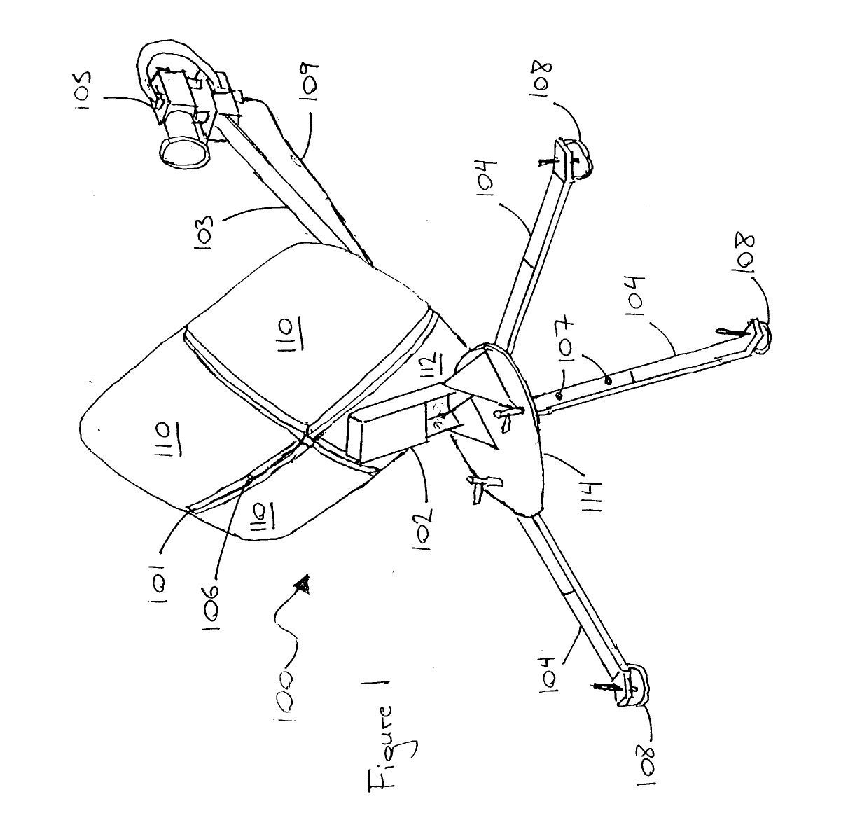

FIG. 1 depicts the preferred embodiment illustrating how the components of the invention are interconnected and assembled to form a complete portable antenna assembly 100. Portable antenna assembly 100 is seen to be composed of the following major components: antenna reflector 101, backing plate 102, mounting platform 114, tripod legs 104, boom arm 103, and feed horn assembly 105.

Antenna reflector 101 is seen to be composed of four separable parabolic segments 110, 112 each comprising approximately one quarter of the full antenna reflector 101. Parabolic segment 112 is attached to the backing plate 102. Whilst the shape of conventional antennas is normally elliptical, the antenna reflector 101 of the present invention is approximately square or rectangular. This shape achieves an optimum illuminated area, whilst providing the optimum shape for compact packaging and transport. The rectangular shape results in antenna segments that fit conveniently and efficiently into a rectangular case. However, as is obvious to those skilled in the art, other shapes, both of the antenna reflector 101 and of the antenna segments 110, 112, may be used in order to fit into carrying cases of different shapes and/or sizes.

The four segments 110, 112 of antenna reflector 101 are mechanically connected to one another along their edges by means of a multiplicity of built-in quarter turn, quick release cam nuts 106, (only one of which is shown for purposes of illustration).

A receive cable 109 is used to connect the feed horn assembly 105 to a connector on backing plate 102.

The feed horn assembly 105, supported by the boom arm 103, is located at the focal point of the antenna reflector 101. The boom arm 103 is attached to the lower part of that parabolic segment 112 of the antenna reflector 101, which is attached to the backing plate 102, and extends to the focal point of the antenna reflector 101. Since the length of the boom arm 103 is likely greater than the maximum desired dimension of the portable antenna assembly 100 when it is collapsed and stowed for transport, (i.e. the boom arm 103 is longer than segments 110, 112) the boom arm 103 consists of two sections of approximately equal length, which can are reversibly connected to form the complete boom 103.

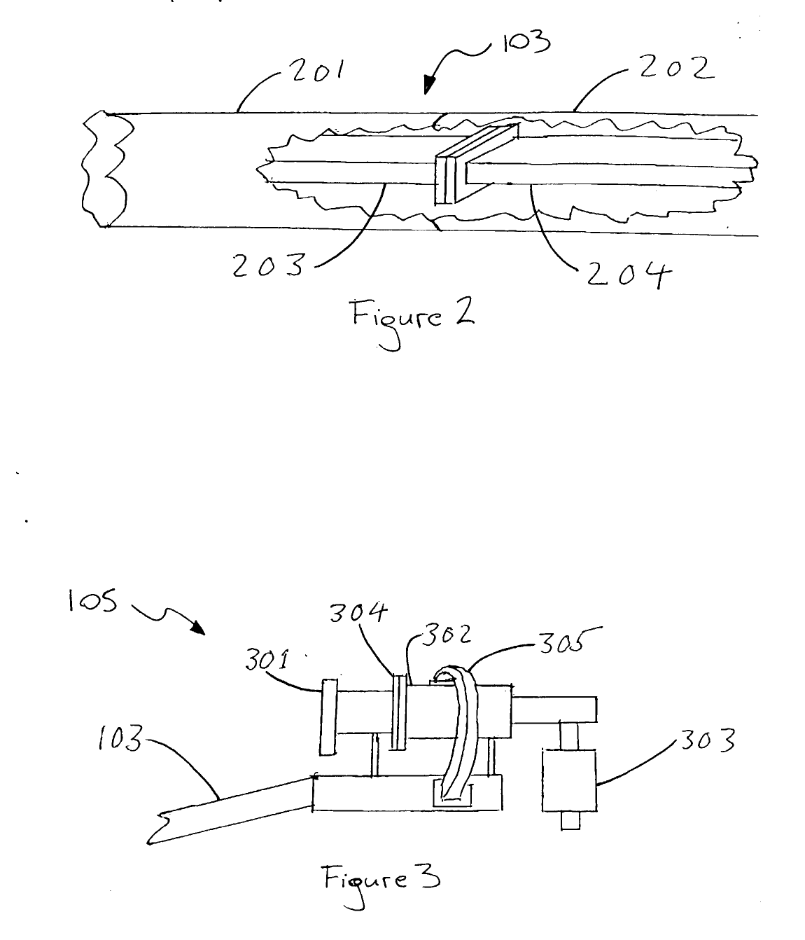

The boom arm 103 is shown in greater detail in FIG. 2. In the preferred embodiment, the boom arm 103 is in the form of a hollow-tube of circular cross-section, comprising two separable sections, inner section 201 and outer section 202. The boom arm 103 is shown to enclose two waveguide sections 203 and 204. The waveguide sections 203, 204 are of approximately equal length. The lengths of the waveguide sections 203, 204 and of the inner and outer sections 201, 202, are equal to or less than the longest dimension of the parabolic segments 110, 112 of the antenna reflector 101.

The boom arm 103 is also used as a means for connecting the output of a transmit assembly (not shown) to the feed horn assembly 105. This is accomplished by locating the two waveguide sections 203, 204 within the boom arm 103. These two sections of waveguide 203, 204 are disconnected from one another for transport when the boom arm sections 201, 202 are disconnected.

FIG. 3 depicts the feed horn assembly 105, which consists of the antenna feed horn 301, the ortho mode transducer 302, the low noise block receiver 303, and the circular rotation joint 304. The circular rotation joint 304 permits the ortho mode transducer to be rotated in order to align the polarization of the antenna feed horn 301 with that of the satellite with which communication is to be established, whilst maintaining the feed horn assembly 105 itself fixed with respect to, the antenna reflector 101. Flexible waveguide 305 is used to connect the waveguide section 204 contained within boom arm 103 to the transmit port on the ortho mode transducer 302.

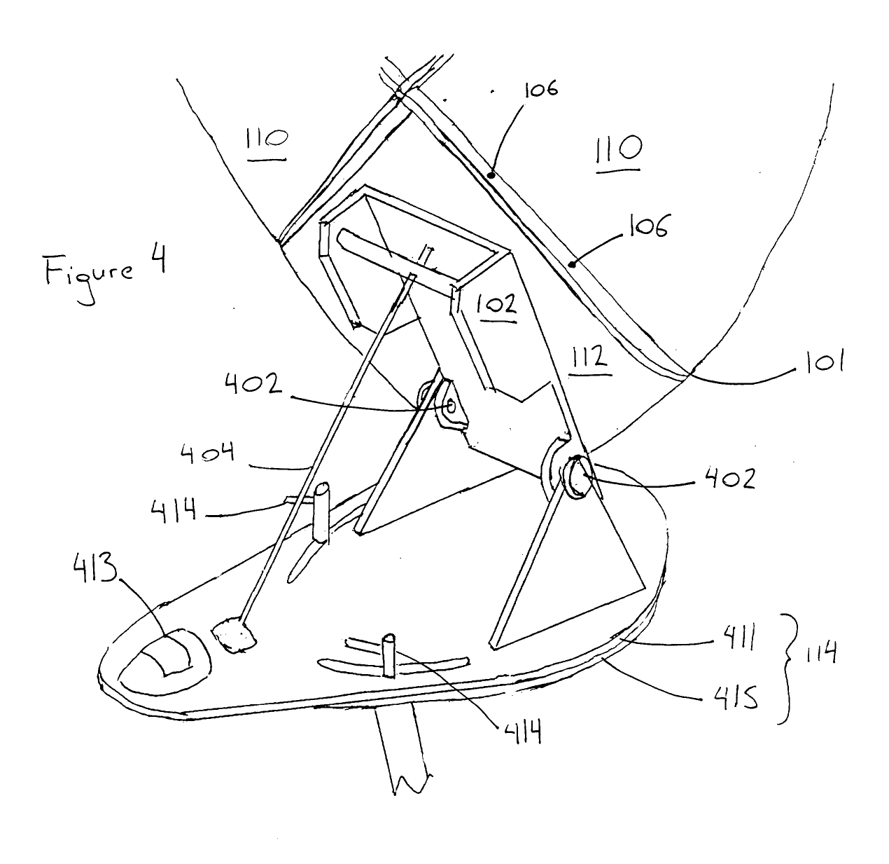

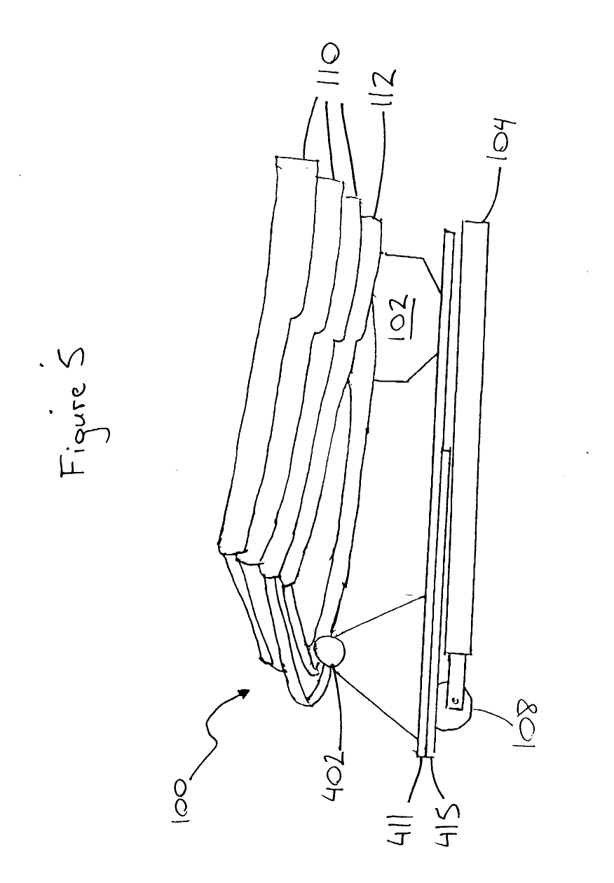

FIG. 4 illustrates how one parabolic segment 112 of the antenna reflector 101 is attached to a backing plate 102. In the preferred embodiment a transmit assembly (not shown) is mounted to the backing plate (referring again to FIG. 1, receive cable 109 connects the feed horn assembly 105 to the transmit assembly via a connector on backing plate 102). The transmit assembly typically consists of a DC power distribution unit, an RF monitor, a transmitter, and a high power microwave amplifier, however, other transmit assembly configurations may be used without departing from the scope of the present invention.

With reference to FIG. 4, the backing plate 102 contains two hinge points 402 located at attachment points to top plate 411. The purpose of the hinge points 402 is to permit the inclination of the antenna reflector 101 to the desired elevation angle in order to point at a satellite. Backing plate 102 also includes an inclinometer (not shown), which permits measurement of the angle of inclination of the antenna reflector 101. An adjustable elevation rod 404, connected at one end to the backing plate 102 and at the other end to the top plate 411, is operative to adjust the angle of inclination of the antenna reflector 101. The elevation rod 404 is removable, thus permitting backing plate 102 to be folded down parallel to top plate 411 for compact stowage. There is also a level detector (not shown) incorporated into the top plate, to facilitate leveling of the overall apparatus when deployed.

The distance by which hinge points 402 are offset from top plate 411 is selected such that the transmit assembly (not shown) mounted on the backing plate 102 fits into the space between the backing plate 102 and top plate 411 when the antenna reflector 101 is folded down against the top plate 411 for stowage and/or transport.

Backing plate 102 also provides an interface of low thermal resistance to enable efficient heat transfer from the transmit assembly through the backing plate 102, to the top plate 411. The mounting platform 114 is thereby used as a heat sink.

Referring again to FIG. 4, the mounting platform 114 comprises two nearly circular plates, the top plate 411 and the bottom plate 415, which swivel about a central point. The mounting platform 114 enables the antenna to be pointed in any direction in a horizontal plane. Fixing the position of top plate 411 with respect to bottom plate 415 is achieved by means of clamps 414. When the clamps 414 are tightened, movement of the top plate 411 with respect to the bottom plate 415 is restricted. A compass 413 is attached to the top plate 411 to enable measurement of the azimuth.

Bottom plate 415 has attachment points (not shown) for reversible attachment of tripod legs 104. Referring to FIGS. 1 and 4, each tripod leg 104 is telescopically extendable, comprising two square aluminum tubes of approximately equal length. Between the two surfaces of the tubes is a layer of Ultra-High-Molecular-Weight Polyethylene, which acts as a bearing, sealing and sliding surface. Each leg 104 has two spring-loaded pins 107; one to retain the respective leg 104 in the retracted position and another to retain leg in the extended position. The spring-loaded pins 107 are located on the top surface of each leg 104 and are covered with a flexible neoprene membrane to seal against dust and dirt, whilst still permitting movement of the spring-loaded pins 107.

Referring again to FIG. 1, the end of each tripod leg 104 that is in contact with the ground has a threaded level adjustment foot 108. Each threaded level adjustment foot 108 consists of a length of threaded rod that is positioned in a threaded hole in the end of the respective tripod leg 104. The threaded level adjustment feet 108 can be used to fine tune the overall length of the respective tripod legs 108 and to level the portable antenna assembly 100 on uneven surfaces.

In FIG. 5, the portable antenna assembly 100 is shown in the collapsed or folded state so that it may be conveniently transported in a case by one person. The antenna reflector 101 is disassembled and three of the antenna segments 110 are stacked one on top of the fourth segment 112, (attached to the backing plate 102) such that the segments 110, 112 occupy a minimum volume. The antenna segment 112 is folded down about hinge point 402 such that it is parallel with top plate 411. The tripod legs 104 are detached and placed against the mounting platform 114. Only one Tripod Leg 104 is shown, telescopically retracted.

Although the various components of the present invention have only been referred to generically in the description of the present invention, the implementation of the various components of the present invention will be easily and readily accessible to those skilled in the art of communications systems. It will be readily apparent to those skilled in the art that many modifications and variations could be effected without departing from the spirit or scope of the novel concepts of the present invention.

Accordingly, while this invention has been described with reference to illustrative embodiments, this description is not intended to be construed in a limiting sense. It is therefore contemplated that the appended claims will cover any modifications or embodiments as fall within the true scope of the invention.

1. A portable antenna assembly for transmission and reception of signals to and from a satellite, comprising:
a) a parabolic antenna reflector comprising a plurality of segments of substantially identical size and shape, said segments removably couplable to one another along their respective edges to form said antenna reflector;
b) a mounting platform for supporting said antenna reflector, said mounting platform pivotably connected to a first one of said segments to permit adjustment of an angle of inclination of said antenna reflector;
c) a boom arm removably couplable to said first segment; and
d) a feed horn assembly located at a focal point of said antenna reflector, said feed horn assembly removably couplable to and supported by said boom arm;
said antenna assembly capable of taking on a compact form wherein said segments are uncoupled from one another, said first segment is pivoted to a position substantially parallel and adjacent to said mounting platform, and remaining ones of said segments are stacked on top of and aligned with said first segment.

2. An antenna assembly according to claim 1, wherein said mounting platform comprises a top plate and a bottom plate, said top plate rotatable about a swivel point with respect to said bottom plate such that an azimuth of said antenna reflector can be adjusted.

3. An antenna assembly according to claim 1, wherein said boom arm encloses a waveguide for transporting a transmit signal to said feed horn assembly.

4. An antenna assembly according to claim 1, wherein said boom arm is comprised of two removably couplable sections of substantially equal length.

5. An antenna assembly according to claim 4, wherein said length of said sections of said boom arm is less than or equal to a longest dimension of said segments.

6. An antenna assembly according to claim 1, wherein said antenna reflector is substantially rectangular in shape.

7. An antenna assembly according to claim 1, wherein said feed horn assembly comprises:
a) an antenna feed horn;
b) an ortho mode transducer;
c) a low noise block downconverter; and
d) a circular rotation joint.

8. An antenna assembly according to claim 1, wherein a backing plate is attached to a back side of said first segment, said backing plate pivotably connected to said mounting platform.

9. An antenna assembly according to claim 8, further comprising a transmit assembly fixed to said backing plate.

10. An antenna assembly according to claim 9, wherein said transmit assembly comprises a DC power distribution unit, an RF monitor, a transmitter, and a high power microwave amplifier.

11. An antenna assembly according to claim 9, wherein said backing plate is of low thermal resistance to enable efficient heat transfer from the transmit assembly via said the backing plate to said mounting platform.

12. An antenna assembly according to claim 1, further comprising a plurality of telescopically extendible legs, said legs reversibly couplable to said mounting platform.

13. A method of collapsing a portable antenna assembly comprising:
a) providing a parabolic antenna reflector comprising a plurality of segments of substantially identical size and shape, said segments coupled to one another along their respective edges to form said antenna reflector, and a mounting platform for supporting said antenna reflector, said mounting platform pivotably connected to a first one of said segments to permit adjustment of an angle of inclination of said antenna reflector;
b) uncoupling said segments from one another;
c) pivoting said first segment to a position substantially parallel and adjacent to said mounting platform; and
d) stacking remaining ones of said segments on top of said first segment.

14. A method according to claim 13, wherein said mounting platform comprises a top plate and a bottom plate, said top plate rotatable about a swivel point with respect to said bottom plate such that an azimuth of said antenna reflector can be adjusted.

15. A method according to claim 13, wherein said antenna reflector is substantially rectangular in shape.
